(19) United States
(12) Patent Application Publication
(10) Pub. No.: US 2009/0006520 A1
(43) Pub. Date: Jan. 1, 2009

(54) Multiple Thread Pools for Processing Requests

(75) Inventors: Elbio Renato T. Abib, Redmond, WA (US); Eric S. Fleischman, Redmond, WA (US); Matthew S. Rimer, Kirkland, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/770,498

(22) Filed: Jun. 28, 2007

(51) Int. Cl. G06F 15/16

(52) U.S. Cl. 709/201

(57) ABSTRACT

In embodiments, servers within a distributed system include more than one thread pool from which threads may be allocated for processing requests received at the servers. The servers have a local thread pool from which threads for processing requests that require only local resources (resources stored locally on the server) are allocated. In embodiments, the server will include a remote thread pool from which threads are allocated for processing requests that require resources stored on any remote server. In other embodiments, the server will include a corresponding thread pool for each of a number of specified remote servers. When a request requires access to resources stored on a particular server, a thread from the corresponding thread pool associated with the particular server will be allocated for processing the request.

### BACKGROUND

Servers, that are part of distributed systems, often process requests received from client or other servers. In order to process the requests, severs must access resources within the distributed system. An example of a distributed system is a distributed directory service, which stores a directory across a number of directory servers and, among other protocols, can be accessed using a Lightweight Directory Access Protocol (LDAP). When a request arrives at a directory server, the request is added to a request queue and is processed according to the order it was received. Usually directory servers are implemented in such a way that they can process several requests concurrently, where a common approach is the use of a thread pool with a number of threads. A server will allocate a thread from the thread pool to process a request, which reduces the number of threads in the pool available for processing other requests.

The number of threads in a thread pool is a precious resource. If the number of threads is too low, there will be less concurrency, potentially reducing overall request processing throughput. On the other hand, if the number of threads chosen is too large, more time is wasted with context changes among threads and there is a greater chance of lock contention (threads requiring exclusive access to the same resources), which also results in a decrease of the server throughput.

Directory servers sometimes require access to information stored in other servers (e.g., directory servers) as part of the processing of certain requests. To access the information, they must transmit server-to-server requests. These server-to-server requests require the consumption of a thread from the thread pool. Problems are created in those situations where some of the directory servers in the distributed system are not behaving correctly and as a result are responding to server-to-server requests with a long delay. When a directory server is processing a request that requires interaction with the malfunctioning servers they will have a thread from their thread pool blocked while they wait for responses from the malfunctioning servers.

The problem grows worse when requests do not have timeout options, which can lead to a situation in which all threads from a directory server's thread pool are used, resulting in a complete collapse of the distributed system. In these situations, directory servers are unable to process even those requests that require local data only, because all of the threads have been blocked waiting for responses from the malfunctioning servers.

It is with respect to these and other considerations that embodiments of the present invention have been made. Also, although relatively specific problems have been discussed, it should be understood that embodiments of the present invention should not be limited to solving the specific problems identified in the background.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

Described are embodiments directed to use of more than one thread pool for processing requests to access resources in a distributed system. In embodiments, each of the servers within the distributed system include more than one thread pool from which threads may be allocated for processing requests received at the server. The servers have a local thread pool from which threads for processing requests that require only local resources (resources stored locally on the server) are allocated. In embodiments, the server includes a remote thread pool from which threads are allocated for processing requests that require resources stored on a remote server. In other embodiments, the server includes a separate thread pool for each of specific remote servers.

Embodiments may be implemented as a computer process, a computing system or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

### BRIEF DESCRIPTION OF THE DRAWINGS

Non-limiting and non-exhaustive embodiments are described with reference to the following figures.

FIG. 1 illustrates a distributed system, according to an embodiment.

FIG. 2 illustrates an environment for processing requests, according to an embodiment.

FIG. 3 illustrates a second environment for processing requests, according to a second embodiment.

FIG. 4 illustrates an environment for processing requests, according to another embodiment.

FIG. 5 illustrates an operational flow for processing requests, according to an embodiment.

FIG. 6 illustrates a second operational flow for processing requests, according to another embodiment.

FIG. 7 illustrates a block diagram of a computing environment suitable for implementing embodiments.

### DETAILED DESCRIPTION

Various embodiments are described more fully below with reference to the accompanying drawings, which form a part hereof, and which show specific exemplary embodiments for practicing the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

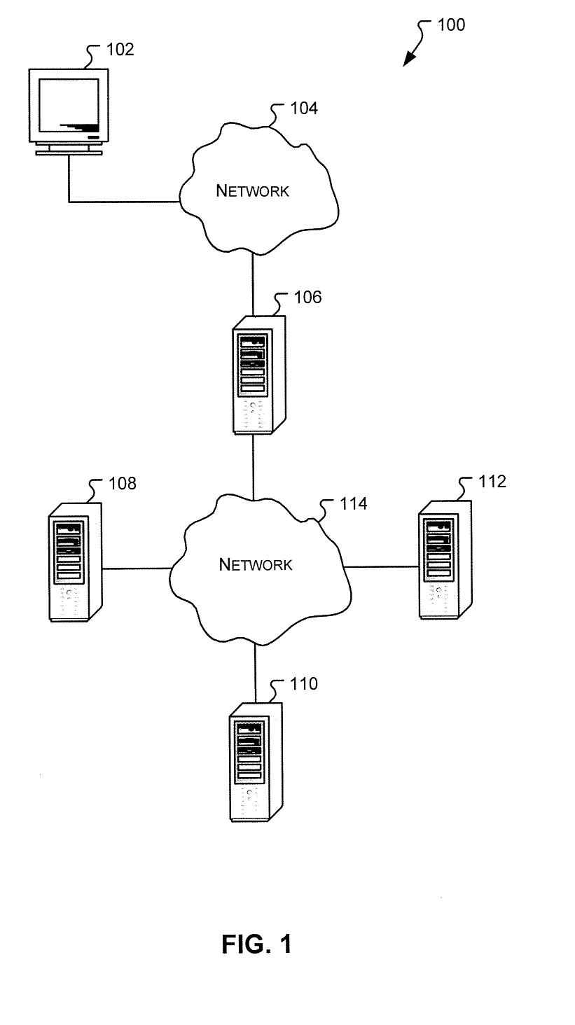

FIG. 1 illustrates a distributed system 100, according to an embodiment. System 100 includes a client computer system 102 that may access, through network 104, a number of nodes illustrated in FIG. 1 as server computer systems 106, 108, 110, and 112. Servers 106, 108, 110, and 112 store information such as a distributed file system or a distributed directory. Servers 106, 108, 110, and 112 are connected to each other through network 114. Client 102 issues requests to server 106, which processes the requests. In processing the requests, server 106 accesses resources in system 100, such as files, databases, directories, etc. The resources may be local (stored on server 106) or remote (stored on servers 108, 110, and 112). If the resources required to process the requests are stored remotely, server 106 will issue any server-to-server requests (to servers 108, 110, and 112) that are necessary to process the request received by client 102.

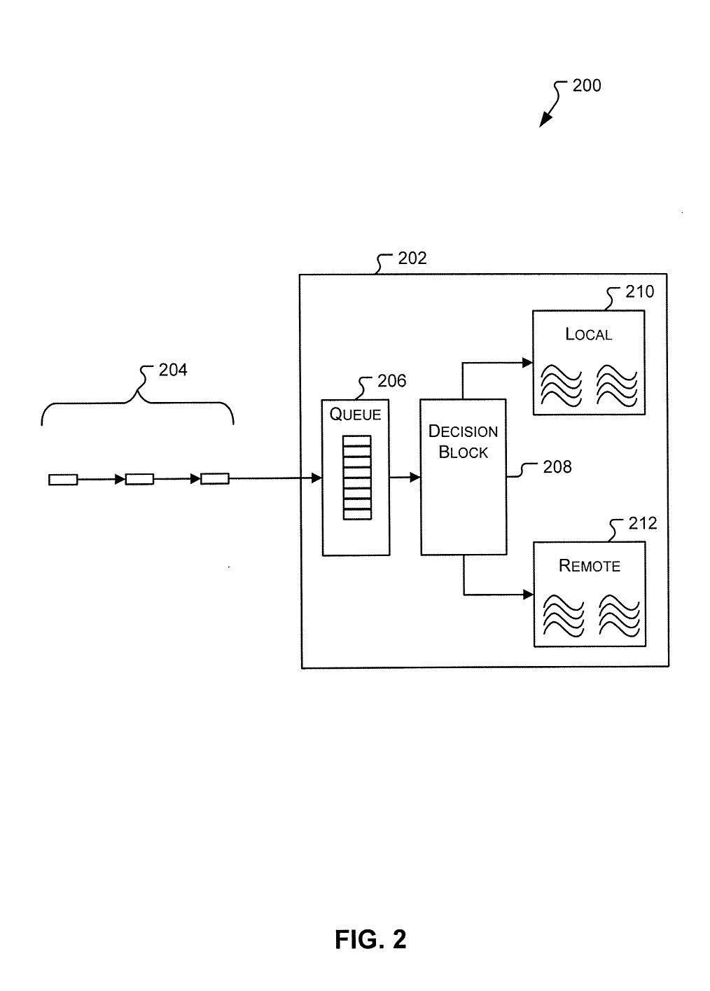

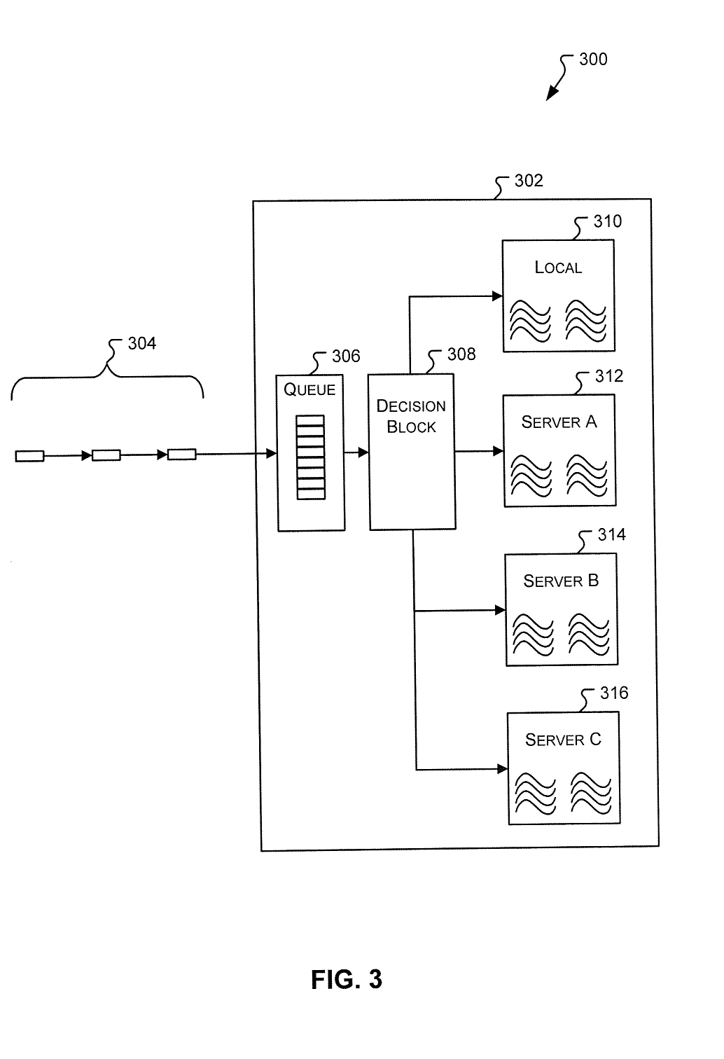

Each of servers 106, 108, 110, and 112 include multiple thread pools, and each implement a mechanism for allocating different threads from the multiple thread pools to process different types of requests. Specific embodiments illustrating multiple thread pools and the mechanisms for allocating threads from the multiple thread pools are described below with respect to FIGS. 2 and 3.

Generally, system 100 operates as follows. Client 102 issues a request to server 106. The request may relate to for example, reading from, writing to, or creating a file or directory. When server 106 receives the request, it determines whether the request requires resources stored remotely on any of servers 108, 110, and 112, or if all of the information required to process the request is found locally. Based on the determining, server 106 will decide from which pool to allocate a thread for processing the request. If the request requires only local information, then server 106 will allocate a local thread. However if the request requires information from other servers in order to process, server 106 will allocate a thread from a separate pool designated for processing requests that require access to information stored on a remote server. More specific embodiments are described in relation to FIGS. 2 and 3.

It should be understood that system 100 is non-limiting and is for illustration purposes only. For example, FIG. 1 illustrates only a single client 102, which is connected to server 106 through network 104. As those with skill in the art will appreciate, in embodiments there may be more than one client each of which can send requests to any of servers 106, 108, 110, and 112 through network 104 and/or other networks. Also, networks 104 and 114 may be any type of computer network that is useful in connecting computer systems. Networks 104 and 114 for example may be a local area network (LAN) or wide area network (WAN). In some embodiments, networks 104 and 114 include an intranet, the Internet and/or combinations thereof. Further, although system 100 shows only four servers, in embodiments, system 100 may include more, or less, than four servers.

FIG. 2 illustrates an environment 200 according to an embodiment. Environment 200 includes a server 202 that in embodiments is part of a distributed system, such as system 100 illustrated in FIG. 1. Server 202 includes a queue 206, a decision block 208, a local thread pool 210, and a remote thread pool 212. In embodiments, the components of server 202 are implemented in servers 106, 108, 110, and 112, described above with respect to FIG. 1. Server 202 receives a number of requests 204. In embodiments, the requests are issued by clients who want to read or write information in the distributed system. Alternatively, the requests are issued by servers within the distributed system.

In embodiments, servers 106, 108, 110, and 112 store a distributed directory service. In one specific example, each of the servers store an ACTIVE DIRECTORY® directory service. For accessing the ACTIVE DIRECTORY® directory service, clients and servers use the Lightweight Directory Access Protocol (LDAP). Thus, in these embodiments client 102 will send LDAP requests to server 106.

As seen in FIG. 2, server 202 receives a number of requests 204. When received by server 202, the requests 204 are stored in queue 206. Server 202 uses queue 206 to store requests that server 202 cannot immediately process. The requests 204 are stored in queue 206 until server 202 has an opportunity to process the requests. When server 202 is ready to process a request, it will retrieve a request from queue 206.

After receiving a request from queue 206, server 202 uses decision block 208 to determine whether processing the request will require exclusively local resources to process, or if it requires resources stored on a remote server (i.e., external data). If decision block 208 determines that the request requires only local data to process, server 202 will allocate a thread from local thread pool 210. However, if decision block 208 determines that the request requires resources stored remotely, server 202 will allocate a thread from remote thread pool 212. After a thread has been allocated for processing the request, server 202 will process the request, including issuing any server-to-server requests that are required. Once server 202 has finished processing the request, the thread used to process the request is included back into the pool from which the thread was originally allocated. The thread can then be allocated again to process a different request.

In embodiments, an administrator decides how many threads should be included in each of local thread pool 210 and remote thread pool 212. As those with skill in the art will appreciate, a number of factors may be considered in deciding how many threads to allocate to each thread pool. For example, there needs to be enough threads in each pool to keep throughput at a reasonable rate. However, too many threads may result in inefficiencies based on a frequent context changes among threads, and lock contention. After an administrator has set the number of threads available in each thread pool no additional threads are added to the thread pools. That is, if the threads in one of the pools are exhausted, then no request which requires a thread from that pool will be processed until an outstanding request has finished processing and the thread returned back into the pool to be used for processing another request.

In other embodiments, a fixed number of threads may be initially provided to each pool, with additional allocation, or withdrawal, of threads occurring automatically during operation. For example, during operation, an algorithm may be used to dynamically determine the optimum number of threads for each pool. The number of threads may then be changed accordingly. As those with skill in the art will appreciate, there are a number of other ways to allocate threads to a pool, and the present invention is not limited to any particular way.

Environment 200 provides a number of advantages over conventional distributed systems. By providing two different thread pools for two different request types, server 202 is less likely to be in a situation where it has no threads available for processing requests. The advantages are realized by differentiating between requests requiring only local data, and requests requiring remote data. If a request requires external data, server 202 will send a server-to-server request to a remote server. Even if the remote server is malfunctioning, or otherwise responding with very long response times, it will have no effect on the number of requests that server 202 can process, which require only local information. Expanding further on this example, if a number of remote servers are malfunctioning, then after a period of time, all of the threads from the remote thread pool 212 will have been used to send server-to-server requests. The threads will be blocked, because the remote servers will not respond to the server-to-server requests. No additional requests requiring external data will be processed by server 202. Nevertheless, because local thread pool 210 is independent of remote thread pool 212, server 202 can continue to process requests requiring only local data, by allocating threads from local data pool 210.

Also in a traditional (single pool) server, if all threads of a server are blocked due to a malfunctioning remote server, an administrator may not even be able to connect to the server to diagnose and correct the problem (e.g., to instruct the server to abort all remote operations). In contrast, server 202 allows an administrator to connect to server 202 (even if a remote server is malfunctioning, and all the threads from pool 212 are blocked,) to take diagnostic and corrective action on the server, because a local thread from pool 210 will still be available.

Environment 200 improves the overall performance and robustness of distributed systems. Implementing the features of server 202 into each server of a distributed system makes the servers less likely to be unavailable. Also, efficiency is improved because any malfunctioning server will not affect the processing of requests requiring only local data. Accordingly, clients will be more likely to have their requests processed making the system more reliable and efficient in processing requests.

It should be understood that in some embodiments, threads from local thread pool 210 may be used to process requests that require resources stored on some remote servers. For example, in some embodiments, remote thread pool 212 can be associated specifically with resources stored on one server, or a group of servers, instead of all remote resources. This could be useful, if a specific server, or group of servers, is identified as being unreliable. In this embodiment, to process requests that require resources stored on the unreliable server, a thread from remote thread pool 212 will be allocated. All other requests (including requests that may require resources from other remote servers) will use threads from local thread pool 210. Thus, the use of local thread pool 210 and remote thread pool 212 provide flexibility in processing requests requiring different resources. Any combination of using multiple thread pools, where one thread pool is designated for processing at least a portion of requests requiring resources stored on a remote server, is contemplated to be within the scope of environment 200.

FIG. 3 illustrates another environment 300 according to a second embodiment. FIG. 3 illustrates a server 302 that is part of a distributed system, such as system 100 illustrated in FIG. 1. In addition to server 302, in this embodiment the distributed system includes at least three additional servers: Server A, Server B, and Server C. Server 302 includes a queue 306, a decision block 308, a local thread pool 310, a Server A thread pool 312, a Server B thread pool 314, and a Server C thread pool 316. In embodiments, the components of server 302 are implemented in servers 106, 108, 110, and 112, described above with respect to FIG. 1. Server 302 receives a number of requests 304. In embodiments, the requests are issued by clients that are requesting information from the distributed system. Alternatively, the requests are issued by servers within the distributed system that are requesting information from server 302.

As shown in FIG. 3, server 302 is similar to server 202 (FIG. 2) in that it differentiates between requests that require only local information to process, and requests that require information from remote servers to process. However, instead of having only a single thread pool for all requests requiring remote resources, server 302 establishes separate thread pools for specific servers. This additional level of granularity allows server 302 to further reduce the risk that it will enter a state where it can no longer process any requests because of blocked threads. Having separate thread pools that correspond to specific remote servers reduces the effect that malfunctioning servers can have on the ability of server 302 to process requests.

Operation of environment 300 generally proceeds as described below. When received at server 302, the requests 304 are stored in queue 306 until server 302 has an opportunity to process each individual request. Server 302 retrieves a request from queue 306, and uses decision block 308 to determine whether the request requires only local data to process, or if it requires information that is stored on another server. If decision block 308 determines that the request requires only local data to process, server 302 will allocate a thread from local thread pool 310, and then process the request.

Alternatively, decision block 308 may determine that the request requires resources stored on a remote server (Server A, Server B, or Server C). Decision block 308 determines which specific server is must be accessed to for process the request. Server 302 will then allocate a thread from the thread pool corresponding to the specific server, server A thread pool 312, server B thread pool 314 or server C thread pool hundred 16. After allocating the thread, server 308 will process the request, including issuing a server-to-server request. Once server 302 has finished processing the request, the thread will be included back into the pool from which the thread was originally allocated. The thread can then be allocated again to process a different request.

To further illustrate the operation, and advantages, of environment 300, assume that Server A is malfunctioning. When server 302 processes requests that require information stored on Server A, it will allocate threads from Server A thread pool 312 until all of the threads from Server A thread pool 312 have been allocated. No further requests that require information from Server A will be processed. However, server 302 will continue to process requests that require only local data, requests that require information from Server B, and requests that require information from Server C. In contrast, conventional servers would continue to allocate threads to the requests that require information from Server A until all of the available threads from their single thread pool are allocated, after which no additional requests (including requests requiring only local resources or resources stored on servers B and C) could be processed.

Using environment 300, =a predetermined number of threads are initially provided to each thread pool. As described above with respect to FIG. 2, the number of threads allocated to a thread pool may be set by an administrator. As those with skill in the art will appreciate, the number of threads allocated to each thread pool will depend on a number of factors such as the information stored on the distributed system, the size of the distributed system (number of servers), and the organization of the distributed system (forest, domains, sites). In one embodiment, a distributed system may be large (i.e. include a large number of servers), which would require the establishment of a large number of thread pools. However, it may be the case that a majority of the servers store resources that are rarely required to process requests. Accordingly, the thread pools corresponding to those servers will be allocated only a small number of threads. While the servers that store information frequently required to process requests will have corresponding thread pools with a large number threads. In other embodiments a distributed system may have a smaller number of servers, and these embodiments the threads may be more equally divided among thread pools

FIG. 2 and FIG. 3 are only examples of possible embodiments and are not intended to be limiting. Other embodiments may include combinations of features described individually with respect to FIG. 2 and FIG. 3. For example, in some embodiments, a server will incorporate both server specific thread pools like server 302 and also include a remote thread pool like server 202. This embodiment may be particularly suitable for larger distributed systems, where it may be impractical, or inefficient to establish a thread pool for every server in the distributed system. Accordingly, server specific thread pools will be established corresponding to those servers that store information frequently required to process requests. While a general remote thread pool can be used to process requests that require information stored on less frequently accessed servers. As another example, servers could be assigned to pools based on their reliability (e.g., servers prone to malfunction could be assigned to their own pools to limit the scope of the damage they can create.) In other embodiments, the server could dynamically expand and contract the number of pools (e.g., the first time a request comes in for a new remote server, it creates a pool for that server; if the remote server hasn't been accessed for a while, it destroys that pool). In other embodiments, a server may implement combinations of the features described above, e.g., the server itself decides how to create and allocate pools based on frequency of requests and observed reliability of the remote servers.

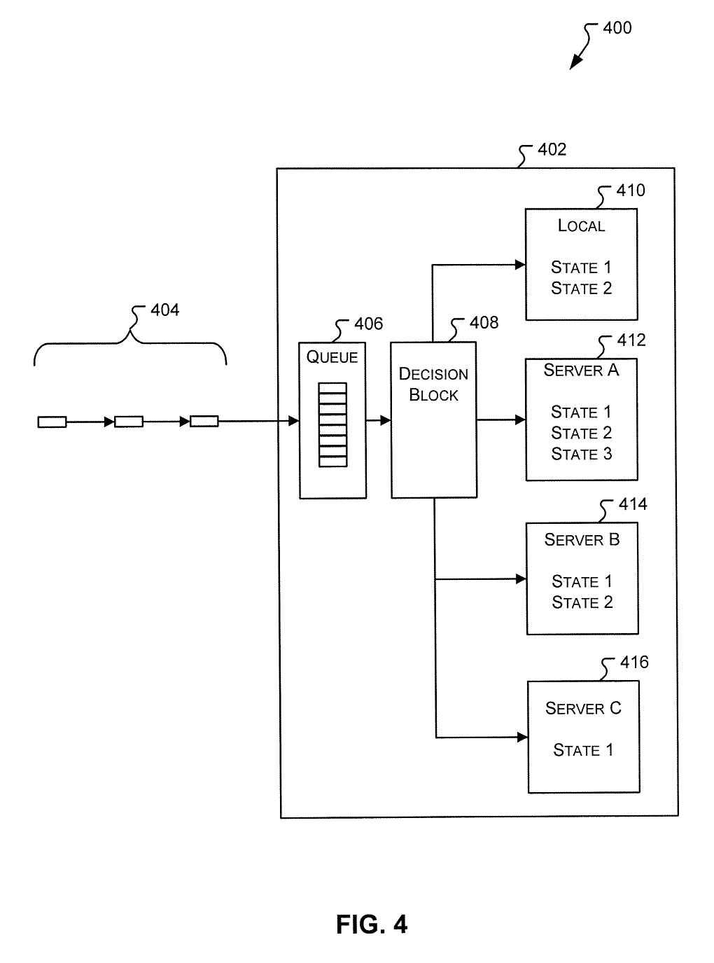

FIG. 4 illustrates an environment 400 according to another embodiment. Environment 400 does not use threads for processing requests. Rather, environment 400 uses asynchronous commands. As those with skill in the art will appreciate, servers that use asynchronous commands may also reach a state where further requests are blocked from being processed. A local server will process server-to-server requests by sending a request to a remote server and storing a “request state” locally while it awaits a response from the remote server. When a response it returned, the request state is deleted. If a remote server is malfunctioning, the local server may store a large number of request states and eventually reach a limit where no additional request states can be stored. As illustrated in FIG. 4 and described below, the concept of differentiating requests based on the specific resources used to process the requests is equally applicable to servers that use threads as well as servers that use asynchronous commands.

FIG. 4 illustrates a server 402 that is part of a distributed system, such as system 100 illustrated in FIG. 1. In addition to server 402, in this embodiment the distributed system includes at least three additional servers Server A, Server B, and Server C. Server 402 does not use threads to process commands, but instead uses asynchronous commands. Server 402 includes a queue 406, a decision block 408, a local state pool 410, a Server A state pool 412, a Server B state pool 414, and a Server C state pool 416. In embodiments, the components of server 402 are implemented in servers 106, 108, 110, and 112, described above with respect to FIG. 1. Server 402 receives a number of requests 404. In embodiments, the requests are issued by clients that are requesting information from the distributed system. Alternatively, the requests are issued by servers within the distributed system that are requesting information from server 402.

Server 402 differentiates between requests that require only local information to process, and requests that require information from remote servers to process. However, instead of storing requests states in a single state pool for all requests requiring remote resources, server 402 establishes separate state pools for specific servers. This additional level of granularity allows server 402 to further reduce the risk that it will enter a state where it can no longer process any requests as a result of having reached a limit of stored request states. Having separate state pools that correspond to specific remote servers reduces the effect that malfunctioning servers can have on the ability of server 402 to process requests.

Operation of environment 400 generally proceeds as described below. When received at server 402, the requests 404 are stored in queue 406 until server 402 has an opportunity to process each individual request. Server 402 retrieves a request from queue 406, and uses decision block 408 to determine whether the request requires only local data to process, or if it requires information that is stored on another server. If decision block 408 determines that the request requires only local data to process, server 402 will process the request and store a request state in local state pool 410.

Alternatively, decision block 408 may determine that the request requires resources stored on a remote server (Server A, Server B, or Server C). Decision block 408 determines which specific server must be accessed to process the request. Server 402 will then send the request to the appropriate server and store a request state in a state pool corresponding to the specific server, server A state pool 412, server B state pool 414 or server C state pool 416. Once server 402 has finished processing the request, the request state corresponding to the request will be removed from the pool in which it was stored.

To further illustrate the operation, and advantages, of environment 400, assume that Server A is malfunctioning. When server 402 processes requests that require information stored on Server A, it will store request states in Server A state pool 412 until Server A state pool 412 reaches its limit. No further requests that require information from Server A will be processed once the limit is reached. However, server 402 will continue to process requests that require only local data, requests that require information from Server B, and requests that require information from Server C. In contrast, conventional servers would continue to save the request states until server 402 reached a limit of request states, after which no additional requests (including requests requiring only local resources or resources stored on servers B and C) could be processed.

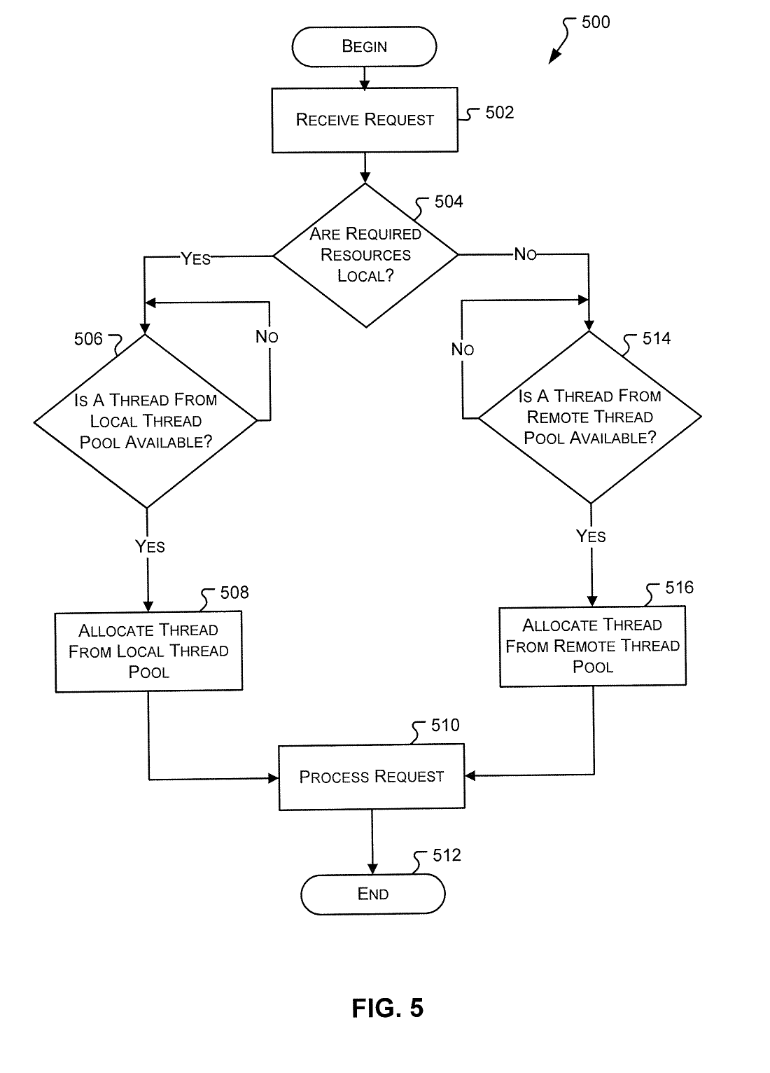

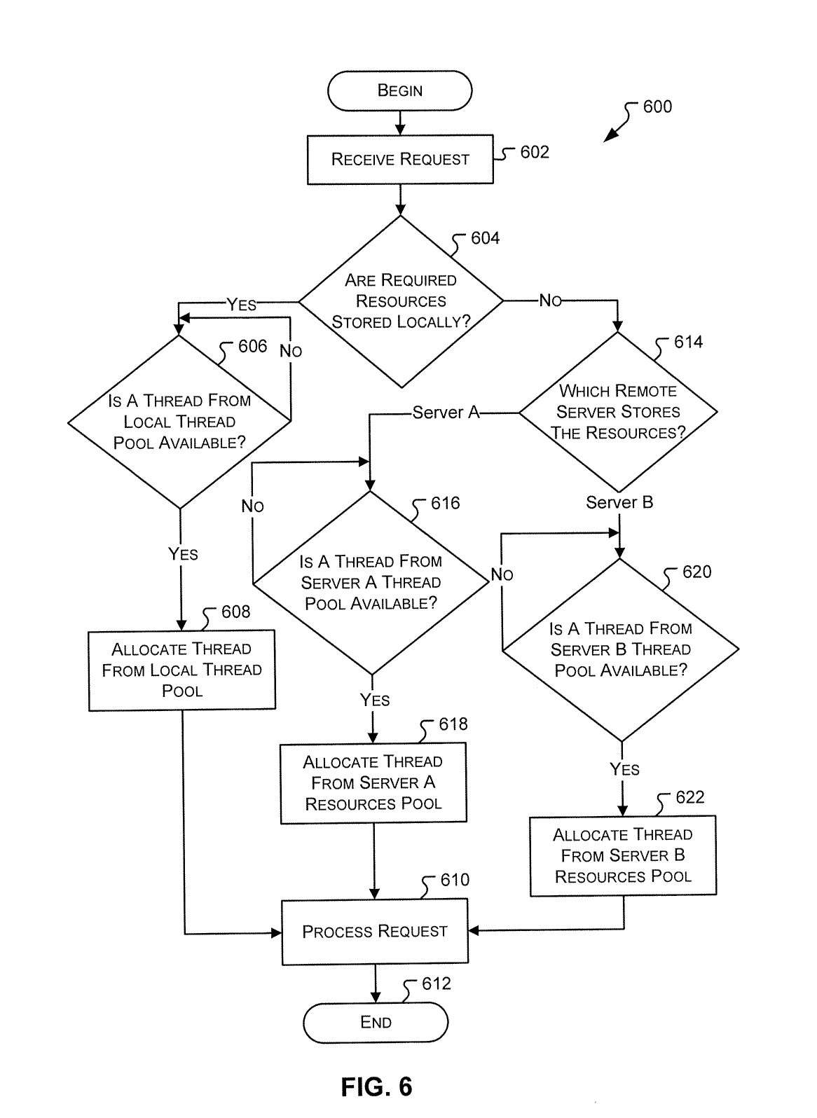

FIGS. 5 and 6 illustrate operational flows 500 and 600, according to embodiments. Operational flows 500 and 600 may be performed in any suitable environment. For example, the operational flows may be executed in environments such as illustrated in FIGS. 1, 2, and 3. Therefore, the description of operational flows 500 and 600 may refer to at least one of the components of FIGS. 1, 2, and 3. However, any such reference to components of FIGS. 1, 2, and 3 is for descriptive purposes only, and it is to be understood that the implementations of FIGS. 1, 2, and 3 are non-limiting environments for operational flows 500 and 600.

Furthermore, although operational flows 500 and 600 are illustrated and described sequentially in a particular order, in other embodiments, the operations may be performed in different orders, multiple times, and/or in parallel. Further, one or more operations may be omitted or combined in some embodiments.

FIG. 5 illustrates an operational flow 500 according to an embodiment, for processing requests received by a server that is part of a distributed system such as system 100 (FIG. 1). In embodiments, flow 500 will be implemented by server 202 (FIG. 2). However, it should be understood that flow 500 is not limited to this specific embodiment. Flow 500 is described below as being implemented by one embodiment of a server that includes two thread pools from which the server can allocate threads for processing requests. One thread pool includes threads used for processing requests that require only local resources (i.e. access to local files, local directory information, local database etc.). A second thread pool includes a second set of threads that are used for processing requests that require resources from remote resources.

Flow 500 begins at operation 502, where a request is received. In embodiments, the request is generated by a client that wants to access resources within the distributed system. A server that is part of the distributed system receives the request from the client at operation 502. For example, in embodiments the request may be generated by client 102 (FIG. 1) and received by server 202 (FIG. 2). In other embodiments, the request is generated by a server in the distributed system.

After request is received at operation 502, flow passes to operation 504. At operation 504, a determination is made whether the resources required to process the request received at operation 502 are all stored locally. If a determination is made that the required resources are all stored locally, then flow passes to operation 506, where a determination is made whether a thread is available from the local resource thread pool for allocating the request. If at operation 506 there are no threads available (i.e. all threads are blocked) flow will loop back to operation 506 until a thread becomes available. If a thread is available flow passes from operation 506 to operation 508, where a thread is allocated from the local resource thread pool. After a thread is allocated at operation 508, the request is processed using the allocated thread at operation 510. Flow then ends at operation 512.

Referring back to operation 504, if a determination is made that at least some of the resources required to process the request are located remotely, flow passes to operation 514. At operation 514 a determination is made as to whether a thread from the remote resource thread pool is available. If a thread is not available, because all threads are blocked, then flow will pass back to operation 514 until a thread becomes available. When a thread is available, flow passes from operation 514 to 516 where a thread from the remote thread pool is allocated for processing the request. Flow then passes to operation 510 where the request is processed. At operation 512, flow ends.

Flow 500 provides a number of advantages over other processes that use only a single thread pool for processing requests, which are susceptible to having all of the threads blocked based on a malfunctioning server. With flow 500, a malfunctioning server can only block a limited number of threads, namely those threads allocated to the remote thread pool. Requests requiring only local resources will continue to be processed.

FIG. 6 illustrates an operational flow 600, according to an embodiment, for processing requests received by a server that is part of a distributed system such as system 100 (FIG. 1). In embodiments, flow 600 will be implemented by server 302 (FIG. 3). However, it should be understood that flow 600 is not limited to this specific embodiment. Flow 500 is described below as being implemented by a server that includes more than one thread pool from which the server can allocate threads for processing requests. One thread pool includes threads used for processing requests that require only local resources (i.e. access to local files, local directory information, local database etc.). The other thread pools each correspond to a different server within the distributed system. For example, the server may have a thread pool corresponding to a server in the distributed system designated as “server A.” If the processing of a request requires resources stored on server A, the thread for processing the request will be allocated from the thread pool corresponding to server A.

Flow 600 begins at operation 602, where a request is received. In embodiments, the request is generated by a client that wants to access resources within the distributed system. A server that is part of the distributed system receives the request from the client at operation 602. For example, in embodiments the request may be generated by client 102 (FIG. 1) and received by server 302 (FIG. 3).

Flow passes from operation 602 to operation 604 where a determination is made as to the location of the resources required for processing the request. If the request requires only local resources for processing, flow will pass from operation 604 to operation 606. At operation 606, a determination is made whether a thread is available from the local thread pool for processing the request. If a thread is not available from the local thread pool, because for all of the threads have been previously allocated, flow loops back to operation 606. After a determination is made that a thread is available from the local thread pool, flow passes to operation 608, where a thread is allocated from the local thread pool for processing the request. The request is processed at operation 610, and flow ends at operation 612.

If operation 604 determines that the request requires resources stored remotely, flow passes to operation 614. Operation 614 determines the remote location where the resources for processing the request are stored. If the resources are stored on server A, flow passes from operation 614 to operation 616, where a determination is made whether a thread from the server A thread pool is available to allocate to the request. If at operation 616 a determination is made that a thread is not available, flow loops back to operation 616 until a thread becomes available. When a thread is available, flow passes from operation 616 to operation 618 where a thread is allocated for processing the request. The request is processed at operation 610 and flow ends at operation 612.

If operation 614 determines that the resources for processing the request are stored on server B, flow passes from operation 614 to operation 620, where a determination is made whether a thread from the server B thread pool is available to allocate to the request. If at operation 620 a determination is made that a thread is not available, flow loops back to operation 620 until a thread becomes available. When a thread is available, flow passes from operation 620 to operation 622 where a thread is allocated for processing the request. The request is processed at operation 610 and flow ends at operation 612.

Flow 600 provides a number of advantages over other processes that use only a single thread pool for processing requests, which are susceptible to having all of the threads blocked based on a malfunctioning server. With flow 600, if server A is malfunctioning, there are only a limited number of threads that will be blocked, namely those threads allocated to the server A thread pool. Requests requiring only local resources, or resources from server B, will continue to be processed.

As explained above, the operations of flow 600 described in FIG. 6 are not intended to be limiting and in other embodiments, flow 600 may include additional operations, or less than the operations illustrated in FIG. 6. In embodiments, flow 600 may include additional operations for allocating threads from more than three thread pools. For example, there may be four, or more, thread pools for allocating threads. One of the thread pools being a local resource thread pool, and the others corresponding to specific servers. In these embodiments, flow 600 will include operations for allocating threads from all of the available thread pools.

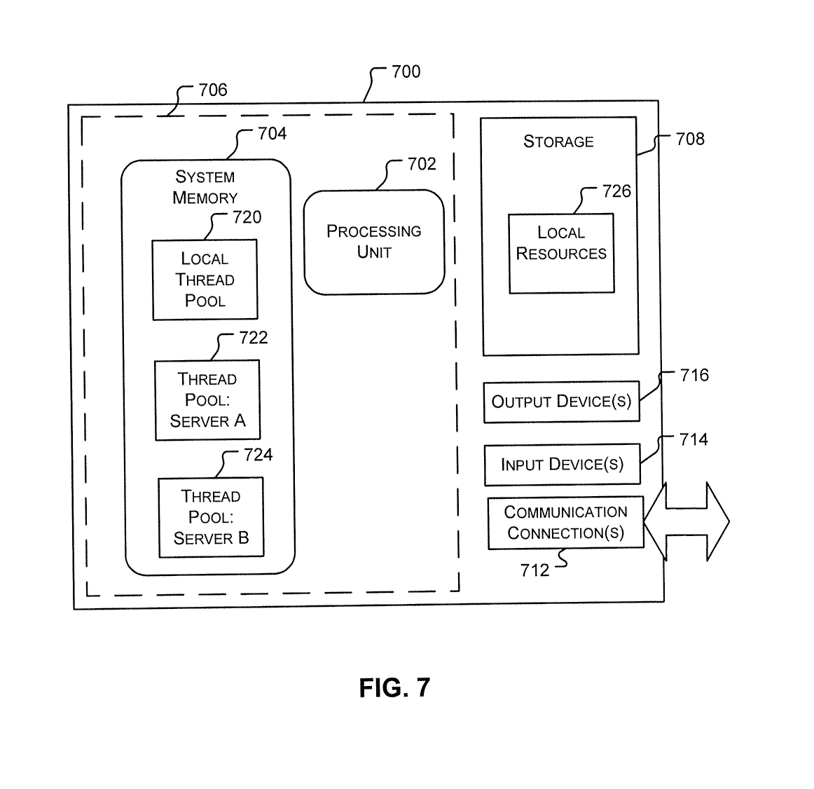

FIG. 7 illustrates a general computer environment 700, which can be used to implement the embodiments described herein. The computer environment 700 is only one example of a computing environment and is not intended to suggest any limitation as to the scope of use or functionality of the computer and network architectures. Neither should the computer environment 700 be interpreted as having any dependency or requirement relating to any one or combination of components illustrated in the example computer environment 700.

In its most basic configuration, environment 700 typically includes at least one processing unit 702 and memory 704. Depending on the exact configuration and type of computing device, memory 704 may be volatile (such as RAM), non-volatile (such as ROM, flash memory, etc.) or some combination of the two. This most basic configuration is illustrated in FIG. 7 by dashed line 706. As shown in FIG. 7, a number of thread pools (720, 722, and 724) described above with respect to FIG. 2 and FIG. 3 may be loaded into system memory 704 to allocate threads for processing requests received by environment 700. The thread pools (720, 722, and 724) are useful when environment 700 is performing flows 500 and 600 described in FIG. 5 and FIG. 6.

Additionally, environment 700 may also have additional features/functionality. For example, environment 700 may also include additional storage 708 (removable and/or non-removable) including, but not limited to, magnetic or optical disks or tape. Such additional storage is illustrated in FIG. 7 by storage 708. As shown in FIG. 7, storage 708 may store resources, such as resources 726 that are necessary for processing requests received by environment 700.

Computer storage media includes volatile and nonvolatile, removable and non-removable media implemented in any method or technology for storage of information such as computer readable instructions, data structures, program modules or other data. Memory 704 and storage 708 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by environment 700. Any such computer storage media may be part of environment 700.

System 700 may also contain communications connection(s) 712 that allow the system to communicate with other devices. Communications connection(s) 712 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Environment 700 may also have input device(s) 714 such as keyboard, mouse, pen, voice input device, touch input device, etc. Output device(s) 716 such as a display, speakers, printer, etc. may also be included. All these devices are well know in the art and need not be discussed at length here.

Reference has been made throughout this specification to “one embodiment” or “an embodiment,” meaning that a particular described feature, structure, or characteristic is included in at least one embodiment of the present invention. Thus, usage of such phrases may refer to more than just one embodiment. Furthermore, the described features, structures, or characteristics may be combined in any suitable manner in one or more embodiments.

One skilled in the relevant art may recognize, however, that the invention may be practiced without one or more of the specific details, or with other methods, resources, materials, etc. In other instances, well known structures, resources, or operations have not been shown or described in detail merely to avoid obscuring aspects of the invention.

While example embodiments and applications of the present invention have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the claimed invention.

We claim:

1. A computer implemented method of processing a request, wherein the processing requires resources stored on a distributed system, the method comprising:
receiving at a receiving server a request for processing, wherein the receiving server comprises a local thread pool and a remote thread pool;
determining by the receiving server where the resources required for processing the request are stored;
in response to a determination that the resources are stored remotely on a remote server, allocating a thread from the remote thread pool for processing the request;
in response to a determination that the resources are stored locally on the receiving server, allocating a thread from the local thread pool for processing the request; and
processing the request.

2. The method of claim 1, wherein the remote server is a first remote server and the remote thread pool is associated with the first remote server.

3. The method of claim 2, wherein the receiving server further comprises a second remote thread pool.

4. The method of claim 3, further comprising:
in response to a determination that the resources are stored remotely on a second remote server, allocating a thread from the second remote thread pool for processing the request.

5. The method of claim 3, wherein the second remote thread pool is associated with a second remote server.

6. The method of claim 1, wherein the remote server is a first remote server, and the method further comprises:
in response to a determination that the resources are stored remotely on a second remote server, allocating a thread from the remote thread pool for processing the request.

7. The method of claim 2, further comprising:
in response to a determination that the resources are stored remotely on a second remote server, allocating a thread from the local thread pool for processing the request.

8. The method of claim 1, wherein the local thread pool comprises more threads than the remote thread pool.

9. The method of claim 1, wherein the receiving server is a directory server.

10. The method of claim 9, wherein the resources comprise a directory and the request relates to accessing the directory.

11. The method of claim 10, wherein the request is in the form of a Light Directory Access Protocol (LDAP) request.

12. A computer readable medium storing computer executable instructions for performing a method of processing a request, wherein the processing requires access to resources stored on a distributed system, the method comprising:
receiving at a receiving server a request for processing, wherein the receiving server comprises a local thread pool, a first server thread pool associated with a first remote server, and a second server thread pool associated with a second remote server;
determining where resources required for processing the request are stored;
in response to a determination that the resources are stored on the receiving server, allocating a thread from the local thread pool for processing the request; and
in response to a determination that the resources are stored on the first remote server, allocating a thread from the first server thread pool for processing the request;
in response to a determination that the resources are stored on the second remote server, allocating thread from the second server thread pool for processing the request.

13. The computer readable medium of claim 12, wherein the receiving server further comprises a remote thread pool, wherein the remote thread pool is not associated with any specific remote server.

14. The computer readable medium of claim 13, further comprising:
in response to a determination that the resources are stored remotely on a remote server that is not one of the first remote server or the second remote server, allocating a thread from the remote thread pool for processing the request.

15. The computer readable medium of claim 12, wherein the receiving server is a directory server.

16. The computer readable medium of claim 15, wherein the resources comprise a directory and the request relates to accessing the directory.

17. The computer readable medium of claim 16, wherein the request is in the form of a Light Directory Access Protocol (LDAP) request.

18. A computer system for processing a request, the system comprising:
a memory storing:
a local thread pool;
a remote thread pool associated with a plurality of remote servers; and
computer executable instructions that when executed perform the steps of:
receiving a request for processing;
determining where the resources required for processing the request are stored;
in response to a determination that the resources are stored remotely on one of the plurality of remote servers, allocating a thread from the remote thread pool for processing the request;
in response to a determination that the resources are stored locally, allocating a thread from the local thread pool for processing the request; and
processing the request; and
a processor for processing the computer executable instructions.

19. The system of claim 18, wherein the resources comprise a directory and the request relates to accessing the directory.

20. The system of claim 19, wherein the request is in the form of a Light Directory Access Protocol (LDAP) request.
